(19) United States
(12) Patent Application Publication
(10) Pub. No.: US 2003/0182403 A1
(43) Pub. Date: Sep. 25, 2003

(54) System and method for program configuration

(76) Inventor: Jeremy S. de Bonet, North Andover, MA (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 10/345,084

(22) Filed: Jan. 15, 2003

Related U.S. Application Data
(60) Provisional application No. 60/348,559, filed on Jan. 15, 2002.
(60) Provisional application No. 60/349,424, filed on Jan. 18, 2002.
(60) Provisional application No. 60/349,344, filed on Jan. 18, 2002.

(51) Int. Cl. G06F 15/177

(52) U.S. Cl. 709/220; 717/176

(57) ABSTRACT

Embodiments of the present invention provide systems and methods for configuring programs substantially reduce or eliminate the disadvantages associated with previously-developed configuration systems and methods. More particularly, embodiments of the present invention provide a system and method for establishing the configuration parameters for a program through a multiple transaction conversation with configuration sources. The conversation can be directed, at least in part, by external logic at the configuration sources and can include a series of requests for configuration parameters and replies containing those parameters. The responses from configuration sources can also include additional request information that can be used by the program being configured to make additional requests for configuration parameters, thereby extending the conversation.

### RELATED APPLICATIONS

The present application claims priority under 35 U.S.C. §119 to U.S. Provisional Patent Application Serial No. 60/348,559, entitled “Dynamic Platform Configuration Via Multiple Transactions with External Logic Control,” by Jeremy S. de Bonet, filed Jan. 15, 2002, U.S. Provisional Patent Application No. 60/349,424, entitled “Network Proxy Platform that Simultaneously Supports Data Transformation, Storage, and Manipulation for Multiple Protocols” by de Bonet et al., filed on Jan. 18, 2002, U.S. Provisional Patent Application No. 60/349,344 entitled “Modular Plug-In Transaction Processing Architecture” by de Bonet et al., filed Jan. 18, 2002, which are hereby fully incorporated by reference herein. Additionally, U.S. patent application Ser. No. ______, entitled “Method and System of Performing Transactions Using Shared Resources and Different Applications,” by de Bonet et al., filed Jan. 14, 2003 is incorporated by reference herein.

### TECHNICAL FIELD

The present invention relates generally to systems and methods of program configuration. More particularly, embodiments of the present invention relate to systems and methods of establishing a set of configuration parameters for a program via multiple transactions.

### BACKGROUND OF THE INVENTION

A program is essentially a set of instructions that are executable by a computer processor to perform a task.

Without any input, the computer processor will typically run the program the same way every time. To increase flexibility, many current software programs allow a variety of settings to be specified when the program is started in order to allow the program to perform differently. An example of such a setting is the default font used by an instance Microsoft®Word (Microsoft is a trademark of Microsoft Corporation, based in Redmond, Washington) that determines the style of characters displayed and printed by Microsoft®Word. When an instance of Microsoft®Word is started, it will retrieve a set of configuration parameters from a configuration source that includes a font parameter. The font parameter will determine the starting font for the instance of Microsoft®Word. If a user wishes to change the font, he or she may be given the option to do so through a user setting, but, unless the font parameter is changed at the configuration source, Microsoft®Word will revert to the initial font each time a new instance is started.

In many current software and hardware systems, a single configuration source or repository is utilized to store configuration parameters. At startup, a program will load the information necessary to query the configuration source and will send a request to the configuration source to get the configuration parameters that dictate the program's run-time characteristics. The configuration source, in an enterprise system, will typically be located on an entity's LAN at a server or database remote from user machines. In other systems, the configuration parameters will be stored locally in a file or command line. The configuration parameters stored in the file, database, server or command line can determine how a program receives inputs, processes data and displays outputs.

Prior art systems of configuring software programs that rely on a single configuration repository tend to be static and do not typically allow the configuration information for a program to change based on a system state. In other words, prior art systems do not allow the settings uploaded by a program to change depending on, for example, the time of day, CPU load or other such factors. Thus, for example, the default font for instances of Microsoft®Word running on an entity's LAN will not change based on time day. In order to change the font, each user will have to change the font through his or her individual user settings. Thus, prior art systems suffer a limitation in that they do not typically allow configuration parameters to change based on system state or be stored across multiple systems.

Additionally, because configuration information is stored at a single source, all configuration information must be maintained at that source, often requiring extensive reprogramming. Therefore it is often difficult to integrate existing sources of potential configuration information into new software systems.

### SUMMARY OF THE INVENTION

Embodiments of the present invention provide systems and methods for configuring programs that substantially reduce or eliminate the disadvantages associated with previously-developed configuration systems and methods. More particularly, embodiments of the present invention provide a system and method for establishing the configuration parameters for a program through a multiple transaction conversation with configuration sources. The conversation can be directed, at least in part, by external logic at the configuration sources and can include a series of requests for configuration parameters and replies containing those parameters. The responses from configuration sources can also include additional request information that can be used by the program being configured to make additional requests for configuration parameters, thereby extending the conversation.

One embodiment of the present invention can include a system for establishing a set of configuration parameters comprising a software program stored on a computer readable memory and executable by a computer processor to: (i) send a first request over a network to a first configuration source; (ii) receive a first response over the network, wherein said first response includes a first portion of the set of configuration parameters; (iii) send a second request over the network to a second configuration source; and (iv) receive a second response over the network, wherein the second response includes a second portion of the set of configuration parameters.

In one embodiment of the present invention, responses generated by a configuration source can include a set of additional request information. The program receiving the response can be executable to generate an additional request based on the additional request information of a previous response. Thus, for example, the second request can be based on the additional request information contained in a previous response. Each additional request can optionally include one or more parameters received in the earlier response. In this manner, values received from one configuration source can be shared with other configuration sources when the additional request is made.

In one embodiment of the present invention, each response generated by a configuration program can be based on a received request. The response can be the same regardless of the request, can be the result of an attribute of the request, such as the originating IP address of the request or request parameters (e.g. user name, time, CPU load or other parameter as would be understood by those of ordinary skill in the art) or can be the result of internal logic such as determining the time at the configuration source. In other words, the response may be the same regardless of the request or may vary depending on the content of the request or system state.

Another embodiment of the present invention can include a method for configuring a program, comprising: (i) sending a first request over a network to a first configuration source; (ii) receiving a first response over the network, wherein said first response includes a first portion of the set of configuration parameters; (iii) sending a second request over the network to a second configuration source; and (iv) receiving a second response over the network, wherein said second response includes a second portion of the set of configuration parameters.

Embodiments of the present invention provide an advantage over previously developed configuration systems by allowing multiple configuration sources to be accessed. This can be advantageous particularly in systems in which different people have control over particular settings. For example, if a user has control over visual preferences in a program while a system administrator has control over the types of file the program can open, parameters controlling visual settings can be stored at one configuration source while parameters controlling file types can be stored at another configuration source.

As another example, in systems with multiple users, configuration information related to different groups of users can be stored in different places.

Embodiments of the present invention provide another advantage by allowing configuration parameters to change depending on information provided by the program being configured or system state information. This can allow a large number of different combinations of configuration parameters to be defined depending on various conditions.

Embodiments of the present invention provide yet another advantage by allowing one configuration source to direct the program being configured to another configuration source. This can allow changes to configuration information to be implemented through changes at the configuration sources, reducing or eliminating reprogramming at user machines. Additionally, this can aid in easily integrating new or legacy data repositories as configuration sources.

### BRIEF DESCRIPTION OF THE DRAWINGS

A more complete understanding of the present invention and the advantages thereof may be acquired by referring to the following description, taken in conjunction with the accompanying drawings in which like reference numbers indicate like features and wherein:

FIG. 1 is a diagrammatic representation of a system for establishing a set of configuration parameters according to one embodiment of the present invention;

FIG. 2 is a diagrammatic representation of a software architecture for establishing a set of configuration parameters according to one embodiment of the present invention;

FIG. 3 is a flow chart illustrating one embodiment of a method for establishing a set of configuration parameters; and

FIG. 4 is a diagrammatic representation of another software architecture for establishing a set of configuration parameters at a proxy program according to one embodiment of the present invention.

### DETAILED DESCRIPTION

Preferred embodiments of the present invention are illustrated in the figures, like numerals being used to refer to like and corresponding parts of the various drawings. Embodiments of the present invention provide systems and methods for establishing the configuration parameters for a program through a multi-transaction “conversation” over a network that dissociates the program from the configuration sources storing the configuration parameters. The conversation can be directed, at least in part, by external logic at the configuration sources and can include a series of requests for configuration parameters and replies containing those parameters. In the preferred embodiment, the conversation can take place using HyperText Transfer Protocol (HTTP), however, any number of communications protocols known (or developed) in the art can be used (e.g. raw TCP/IP, FTP, UDP, HTTPS, Gopher, news, POP, SMTP, SNMP, etc.).

A set of initial configuration parameters can specify an initial request or series of requests to be made by the program. A configuration source can generate an initial response or reply to the request that optionally specifies any number of configuration parameters (e.g. name-value pairs) that the program uses to determine its run-time behavior. In addition, the initial response or reply can include additional request information specifying new requests to be made by the program. The new requests can be inserted into a list of requests that potentially contains additional requests specified by the initial configuration parameters. The program can continue the conversation by making the additional requests (and any other requests specified in response to the additional requests) and incorporating the configuration parameters received.

Each request after the initial request can, in the request itself, include values associated with previously specified parameters. In this manner, parameter values from one configuration source can be included in a request to another configuration source. When the conversation has been completed, the program can use the set of configuration parameters received from the configuration sources to adjust, modify or alter its functionality.

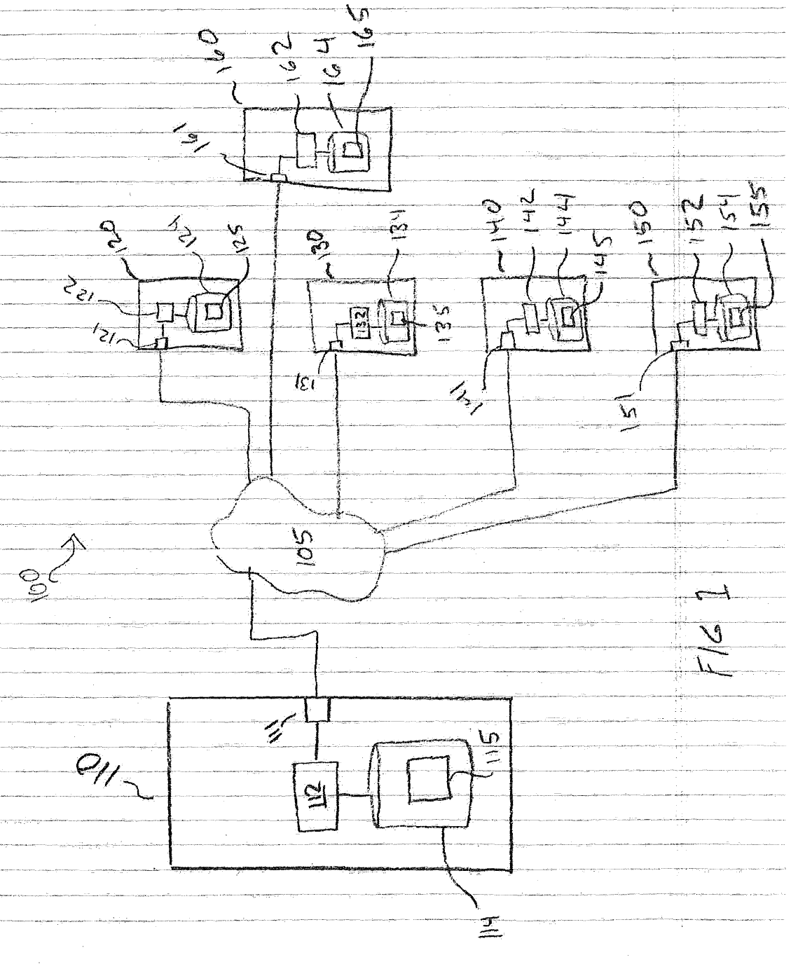

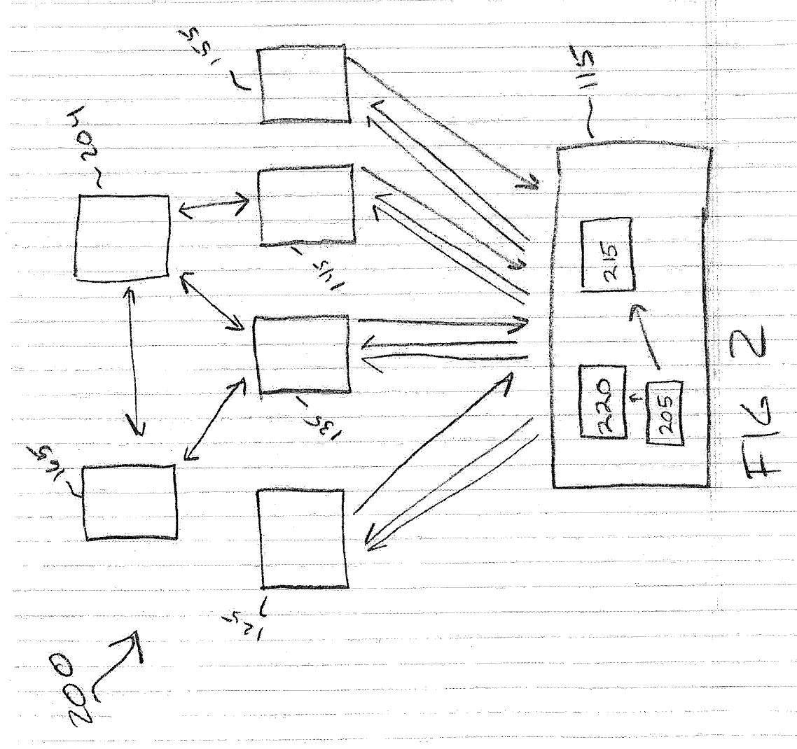

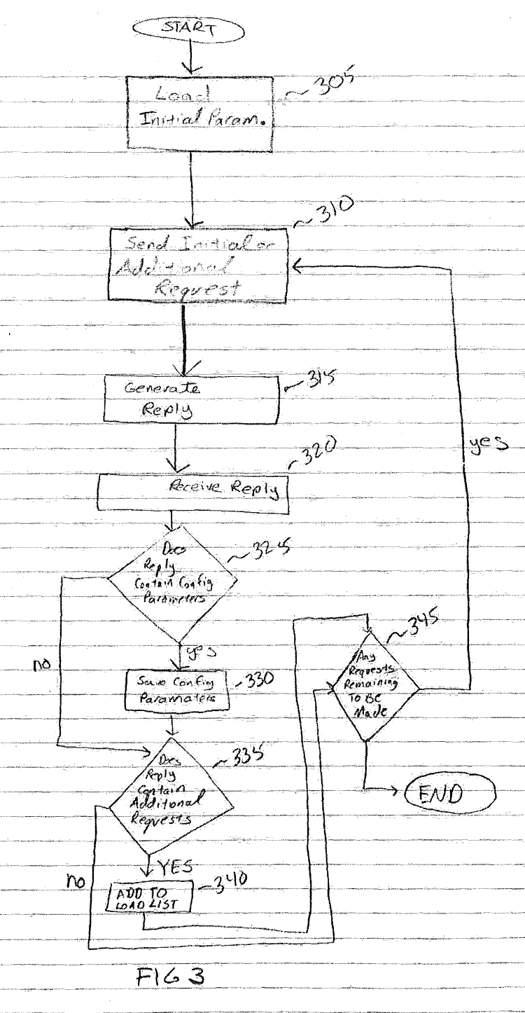

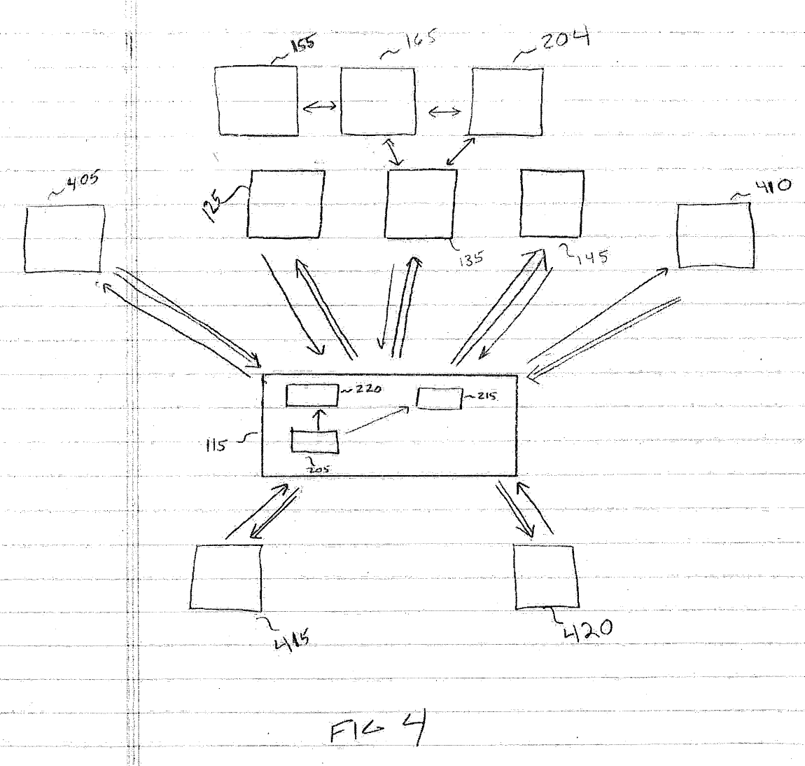

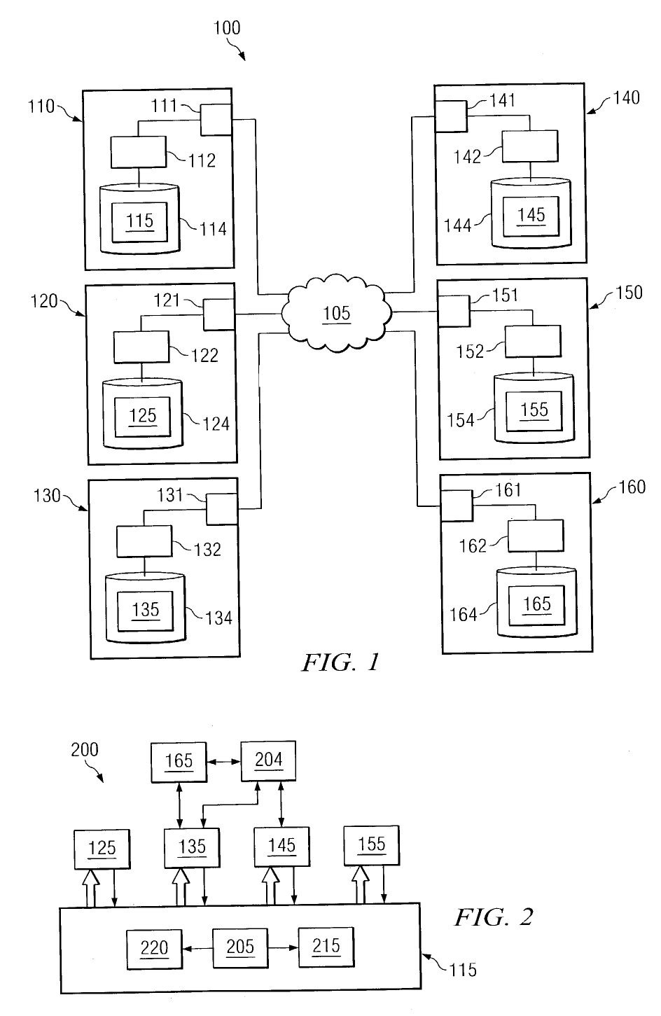

FIG. 1 is a diagrammatic representation of a system 100 for establishing a set of configuration parameters for a software program according to one embodiment of the present invention. System 100 can include a network 105 connecting a first computer 110 and a plurality of configuration sources, (here, indicated as configuration source 120, configuration source 130, configuration source 140, configuration source 150 and configuration source 160). A configuration source can include any system accessible to provide configuration parameters or additional request information, as described below.

Network 105 can be a WAN, LAN, global computer network (e.g. Internet, wireless network, fiber optic network) or any other communications network known in the art. First computer 110 can contain a network communications device 111 (e.g. Ethernet card, modem or other communication device known in the art), a CPU 112 and a computer readable memory 114 (e.g. RAM, ROM, magnetic storage, optical storage device and/or any other computer readable memory known in the art) storing a program 115 that is executable by CPU 112. Program 115 can be a portion of larger program, such as an application, and may be implemented in any suitable programming structure (e.g. plug-in, function, stand alone program) or language known to those of ordinary skill in the art.

Each configuration source can include a network communications device (shown as network communications device 121, network communications device 131 . . . network communications device 161) that can be an any network communications device known in the art. Each configuration source can also include a CPU (shown as CPU 122, CPU 132, CPU 142, CPU 152 and CPU 162) and a computer readable memory (shown as computer readable memory 124, computer readable memory 134 . . . computer readable memory 164) that can comprise RAM, ROM, magnetic storage mediums, optical storage mediums and/or other computer readable memories known in the art and can include a configuration source program (shown as configuration program 125, configuration program 135 . . . configuration program 165). Each configuration program can be a portion of larger program, such as an application, and may be implemented in any suitable programming structure (e.g. plug-in, function, stand alone program) or language known to those of ordinary skill in the art. While first computer 110 and each of the configuration sources 130-160 has been shown as a single physical computer, it should be noted that the functionality of each can be distributed. Moreover, multiple configuration programs can be stored on the same physical machine. Thus, a single computer can comprise multiple configuration sources.

In operation, program 115 can make multiple requests to one or more of the configuration sources via network 105 requesting a set of configuration parameters. The reply from each configuration source can potentially contain: (i) at least a portion of the configuration parameters needed by program 115; and/or (ii) information necessary to make additional requests to other configuration sources. Through the initial request and additional requests (specified by the initial parameters or by responses to requests), program 115 can establish a set of configuration parameters through a multi-transaction conversation with the configuration sources.

Program 115 can initiate a conversation at the occurrence of any predefined event (e.g. startup, receipt of a request from another computer) or according to a schedule. To initiate the conversation, program 115, in one embodiment of the present invention, can load a set of initial parameters. The initial parameters can specify an initial load list comprising a list of configuration sources that are to be queried for additional configuration information. Whether the configuration information is located on the same physical machine as program 115 (potentially held by another application) or on remote machines, the requests for configuration information can be made over a network connection.

Program 115 can make an initial request based on the set of initial parameters to an initial configuration source. Based on the initial request, the initial configuration source can send back a reply including a set of configuration parameters and/or additional request information. As an example, if configuration source 120 is the initial configuration source, configuration source 120 can format a reply to the initial request that includes configuration parameters and additional request information directing program 115 to query configuration source 130. Based on the initial response, program 115 can then send a request to configuration source 130 for additional configuration parameters. Configuration source 130 can, in turn, send a reply containing additional configuration parameters and/or additional request information directing program 115 to query, for example, configuration source 140 for configuration parameters. In this manner, program 115 can query multiple configuration sources to recursively establish a set of configuration parameters that it can use to determine, adjust or modify its run-time characteristics.

FIG. 2 is a diagrammatic representation of a software system 200 according to one embodiment of the present invention. In system 200, program 115 can query any number of a plurality of configuration programs (here, designated configuration program 125, configuration program 135, configuration program 145, configuration program 155, configuration program 165 and configuration program 204), typically hosted remotely from program 115. Program 115 can initially begin with a limited set initial parameters 205 that can specify a load list 215 that includes a list of configuration sources (potentially running on different computers) that are to be queried for additional configuration parameters. Initial parameters 205 and load list 215 can be stored in a database, a file or any other format known in the art.

In operation, program 115 can make an initial request for configuration information to configuration source 120 that can be processed by configuration program 125. The initial request can be a simple request (e.g. an HTTP request such as www.enity.com/configuratonsource1.htm) or can optionally include request parameters such as a set of system state information (e.g. CPU usage at first computer 110) or user information associated with first computer 110. As an example, if first computer 110 is associated with a user “Paul,” the initial configuration parameters can specify that the initial request include a request parameter “user=paul.” If the request is made as an HTTP request, the user name “Paul” can, for example, be included as part of a common gateway interface (“CGI”) request (e.g. www.entity.com/configurationsource1/User?user=paul). It should be noted that HTTP and CGI are provided by way of example only, and the present invention can make requests according to a variety of protocols and interfaces known to those of ordinary skill in the art or later developed. It should be further noted that multiple interfaces (e.g. CGI) running on the same computer can comprise different configuration sources.

Based on the user name “Paul” in the initial request, configuration program 125 can determine that Paul uses a PDA and that Paul is in a specific user group (e.g. the bronze user group). Configuration program 125 can then format a response including, for example, a set of configuration parameters associated with each user that accesses configuration program 125 (i.e. global settings), a set of configuration settings associated with the user Paul (preferred settings, for example) and/or additional request information. The additional request information can specify, for example., that program 115 query configuration source 130 for configuration parameters relating to a specific user device (e.g. PDA) and query configuration source 140 for configuration parameters relating to a particular user group (e.g. bronze). Upon receipt of the initial response, program 115 can store any received configuration parameters as part of set of configuration parameters. 220 and add the additional requests to load list 215.

Continuing with the previous example, program 115 can then make a request to configuration program 135 based on the reply from configuration program 125 that includes information received from configuration program 125 in the request. Thus, for example, program 115 can send a request that has a request parameter indicating the user device is a PDA (e.g. www.entity.com/configurationsource2/Device?device=PDA). In this manner, additional request parameters received from configuration program 125 (e.g. “PDA”) can be shared with configuration program 135. Configuration program 135, can process the request and return a reply that contains additional request information and/or a set of configuration parameters. Program 115 can add additional request(s) to load list 215 and the configuration parameters to the set of configuration parameters 220. While the example request above incorporates request parameters from a previous single reply (e.g. “PDA” from configuration program 125's response), a request can be based on multiple previous responses. For example, program 115 can send a request www.entity.com/configsource/Preferences?device=PDA&group=bronze to a configuration source, even if the device and group parameters came from different previous replies.

In addition to making a request to configuration program 135, program 115 can make a request to configuration program 145 based on the reply received from configuration program 125. Again, program 115 can formulate a request optionally containing additional request parameters received from configuration program 125 (e.g. www.entity.com/configurationsource2/Subscription?group=bronze) and or other configuration programs. Configuration program 145 can receive the request and generate a response containing configuration parameters and/or additional request information, which program 115 can add to set of configuration parameters 220 and load list 215, respectively.

As can be understood from the foregoing, the response generated by each configuration program can be based on the request received from program 115. The response from a particular configuration program (i.e. the configuration parameters and/or additional request information returned in reply to a request) can be the same regardless of the request (i.e. can return a base set of configuration parameters applicable to each requesting program), can be the result of an attribute of the request, such as the originating IP address of the request or parameters stored in the request (e.g. user name, time, CPU load or other parameter as would be understood by those of ordinary skill in the art) or can be the result of internal logic such as determining the time at the configuration source. Additionally, a particular configuration source can query additional configuration sources in formulating a response to a request from program 115. Thus, as shown in FIG. 2, configuration program 145 can query configuration program 165 to generate a reply to a request. If, for example, configuration program 165 is part of a network system that monitors bandwidth usage, and the configuration parameters associated with the “bronze” user group are dependent on the available bandwidth, configuration program 135 can query configuration program 165 prior to responding to the example request www.entity.com/configurationsource2/Subscription?group=br onze. Configuration program 165 can further query other resources, such as configuration program 204 prior to responding to configuration program 135.

Each response to program 115 can optionally include a set of special parameters that contain cache directives for the configuration parameters included in the response (or in the entire conversation). By way of example, a response from a configuration source can contain directives such as “Valid Since First Used 1000 Seconds” and “Valid Since Last Used 500 Seconds” so that configuration parameters in that response will only be cached for 1000 seconds from their first use or 500 seconds from their last use by program 115. In this manner, a configuration source can dictate how long configuration parameters should be cached. In another embodiment of the present invention, the cache directives can apply to all configuration parameters received in a particular conversation, not just a particular response.

In addition each response can include additional request information that specifies one or more additional configuration requests. Program 115 can make the additional configuration requests and incorporate any received configuration parameters into the set of configuration parameters 220. Depending on the order in which program 115 sends out the additional requests, a particular additional request, while potentially based on a previous reply from a configuration source, may not necessarily be based on the immediately proceeding reply. In other words, there can be a number of intermediate requests between a particular additional request and the previous reply on which it is based, depending on the implementation.

Each additional request can, in the request itself, include parameter values that have been previously specified, either in the initial parameters or by one or more previously queried configuration sources. In this way, parameter values from one configuration source, such as the “PDA” value from configuration program 125, can be shared with other configuration sources, such as configuration program 135, when program 115 makes a request. When the “conversation” between program 115 and the configuration sources is complete, a set of configuration parameters 220 has been established that can dictate the operation of program 115 (or other program operable to receive the configuration parameters from program 115) as it performs its other duties.

Embodiments of the present invention, therefore, provide a system for establishing a set of configuration parameters through a multiple transaction conversation. Program 115, in one embodiment of the present invention, can be executable by CPU 112 to send a first request over a network to a first configuration source. The first request can be an initial request dictated by a set of initial parameters or can be based on a previous request. Program 115 can be further executable to receive a first response over the network that contains a portion of the set of configuration parameters and to send a second request to a second configuration source over the network. The second request can be based on a previous response to a previous request. For example, the second request can be based on the response from the first configuration source, on an intermediate response from another configuration source or on several previous responses. The second response can contain a second portion of the set of configuration parameters.

In one embodiment of the present invention, the first response and/or second response can include a set of additional request information. Program 115 can be executable to generate an additional request based on the additional request information of the first response. Thus, for example, the second request can be based on the additional request information contained in the first response. The additional request can optionally include one or more parameters received in the earlier response. In this manner, values received from one configuration source can be shared with other configuration sources when the additional request is made.

In another embodiment of the present invention, load list 215 can define each of the requests to be made by program 115. For example, load list 215 can contain the following requests:

http://www.yoursource.com/UserInfo?user=User ID

http://www.yoursource.com/ClassInfo?class=CLASS

http://www.yoursource.com/Devicelnfo?device=DEVICE

In this case, program 115 can determine the User ID and Device from, for example, initial parameters 205, whereas, the value for the “class” parameter can be defined in a response from the “UserInfo” CGI (e.g. in the additional request information received in response to a request). In another embodiment, the “class” parameter can also be determined by program 115 by initial parameters 205. It should be noted, in this example, each CGI hosted at http://www.yoursource.com can represent a different configuration source.

Because the responses can vary depending on different conditions and system states, embodiments of the present invention can establish various sets of configuration parameters based on the different conditions. Thus, set of configuration parameters 220 can define very specific configuration information for program 115 under one set of conditions to very general configuration information under another set of conditions.

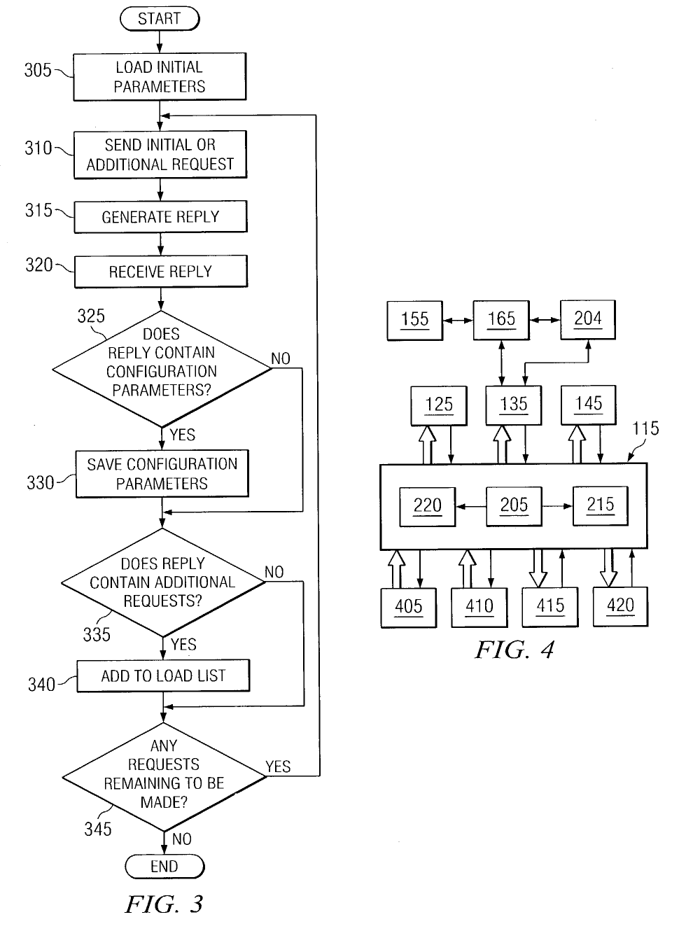

FIG. 3 illustrates a flow chart for implementing a method for establishing the configuration parameters for a program according to one embodiment of the present invention. At step 305, program 115 can load a set of initial parameters stored, for example, in a file or database. The initial parameters can specify an initial load list containing one or more requests to configuration sources. At step 310, program 115 can initiate a conversation with the configuration sources by sending the initial request in load list 215 to the corresponding configuration source. In one embodiment of the present invention, the initial request is sent according to HTTP, though other protocols known (or developed) in the art may be used (e.g. TCP/IP, FTP, UDP, HTTPS, Gopher, news, POP, SMTP, SNMP). The initial request can optionally contain one or more parameters specified by the initial parameters, such as a user name.

Upon receiving the initial request, the configuration source can generate a reply (step 315). If each program requesting information from the configuration source requires the same configuration information, the configuration source can return a stock reply containing the same information. Alternatively, the configuration source can base the reply on information contained in the request, such as the address from which the request originated or a parameter value contained in the request. Thus, for example, the configuration source may generate a different response to the request www.entity.com/configurationsource1/User?user=steve than the request www.eritity.com/configurationsource1/User?user=john.

The configuration source can also base the response on other information, such as a system state. For example, the configuration source can base the response on the time of day, bandwidth usage of a network, amount of memory being used or other factors. The configuration source can derive this information itself or can query another resource (potentially remote from the configuration source) to receive this information.

The response generated by the configuration source can contain a set of configuration parameters, a set of additional request information and/or a set of special parameters. The configuration parameters can be usable by program 115 (or a program that can access the configuration parameters from program 115) to adjust or modify its behavior. The additional request information can be used by program 115 to send new or additional requests to other configuration sources and can include additional request parameters to be sent with an additional request. Alternatively, the additional request information may only include additional request parameters (or values) that are to be sent with requests already defined in load list 215 (e.g. from other previous responses or initial parameters 205). Referring to the example above, if the user “john” is a member of the “gold” group, and the configuration parameters relating to specific users are contained a separate configuration source than configuration parameters relating to groups, a configuration source receiving the request www.entity.com/configurationsource1/User?user=john, can send a response including a set of configuration parameters and a set of additional request information such that program 115 can make the request www.entity.com/configurationsource2/Subscription?group=go ld. In this manner, one configuration source can indicate to program 115 additional configuration sources to be queried and share parameters with those additional configuration sources.

Program 115 can receive the response (step 320) and determine if the response contains one or more configuration parameters (step 325). If the response does contain configuration parameters, program 115 can add the configuration parameters to set of configuration parameters 220 (step 330). Otherwise, program 115 can move to step 335. At step 335, program 115 can determine if the response contains additional request information specifying one or more additional requests. The additional request information can include any information necessary for program 115 to make an additional request to a configuration source and can include parameters to be passed to other configuration sources in one or more of the additional requests. If additional request information is included in a response from a configuration source, the additional requests can be added to load list 215 (step 340). If, on the other hand, additional request information is not included in a response, control can pass to step 345.

Program 115, at step 345, can determine if load list 215 contains any additional requests. If so, program 115 can then send out additional requests in load list 215 (e.g. can return to step 310 by sending out an additional request). The response to each additional request may include configuration parameters that program 115 can add to set of configuration parameters 220 and further additional requests that program 115 can add to load list 215, extending program 115's conversation. Each additional request can include values associated with any parameters that have been previously specified by, for example, previous responses to requests.

When the conversation is complete, program 115 can use set of configuration parameters 220 to adjust, modify or alter its functionality. Alternatively, program 115 can begin using parameters in set of configuration parameters 220 before the conversation is complete, with the conversation dynamically updating set of configuration parameters 220. It should be noted, the process shown in FIG. 3 is by way of example only and embodiments of the present invention can include additional steps and, as would be understood by those of ordinary skill in the art, the steps can be performed in a different order.

Program 115 can, thus, generate a first request, which can be based on a set of initial configuration parameters or a previous request, and receive a first response containing a portion of the configuration parameters.

Additionally, program 115 can generate a second request based on a previous response (e.g. the first response or an intermediate response) to a previous request. The second response can also contain a portion of the configuration parameters. In one embodiment of the present invention, the second request can be based on a set of additional request information received in a previous response and can include request parameters specified in the previous response.

Embodiments of the present invention provide a system and method for establishing the configuration parameters for a program through a multi-transaction “conversation” over a network that dissociates the program from the configuration sources storing the configuration parameters. The conversation can be directed, at least in part, by external logic at the configuration sources and can include a series of requests for configuration parameters and replies containing those parameters. Because the response provided by a configuration source can vary depending on a system state or request parameters, different instances of a program running on a network can receive different configuration parameters at, for example, different times day or according to the network user. This allows embodiments of the present invention to provide a much more flexible set of configurations parameters than traditional single repository models.

Moreover, because the conversation between the program and configuration sources can be arbitrarily extended, new configuration sources can be easily added to a system with minimal or no changes to existing configuration sources. This can allow legacy sources to be utilized without having to port the data in the legacy source to the single configuration repository. For example, if a network operator already has a database of subscriber levels (e.g. gold, silver, bronze), other configuration sources can be modified to include additional request information that directs program 115 to request subscriber information from the subscription database. The subscription database can be provided with a CGI interface (or other interface known or developed in the art) such that program 115 can make a request to the subscription database for subscriber information. Implementing the CGI interface (or other interface known in the art) and modifying one or more other configuration sources can, in some cases, be easier than moving the data from the subscription database to another configuration resource. Program 115, in one embodiment of the present invention, can then make a request (e.g. based on a previous response from another configuration source) to the subscription database and receive subscriber information (e.g. subscription level) in the response. This information can be passed to other configuration sources as one or more request parameters and the other configuration sources can generate responses based on the subscriber information. In this manner, the existing subscription database can be quickly integrated as a configuration source.

FIG. 4 is a diagrammatic representation of another software system 400 according to one embodiment of the present invention. In system 400, program 115 can be implemented as a proxy between client applications (here, indicated as client application 405 and client application 410) and network resources (here indicated as network resource 415 and network resource 420). In one embodiment of the present invention client application 405 and client application 410 can be Internet browsers located on a corporate LAN and network resource 415 and network resource 420 can be web servers located on the Internet. Program 115 can intercept requests from the client applications to the network resources to see if it can fulfill the requests itself from a set of cached web pages. By caching commonly accessed web pages, program 115 can increase the performance of system 400.

When a client application request (e.g. a request for www.idetic.com) is received from client application 405 or client application 410, program 115 can initiate a conversation with one or more configuration programs (here, designated configuration program 125, configuration program 135, configuration program 145, configuration program 155, configuration program 165 and configuration program 204) to gather set of configuration parameters 220. Program 115 can make an initial request to a configuration program (e.g. configuration program 125) based on initial configuration parameters 205 and/or the client application request.

Based on the initial request, configuration program 125 can send back a response that includes configuration parameters, additional request information and/or special parameters. Program 115 can add any configuration parameters received to set of configuration parameters 220 and add any additional requests to load list 215. Program 115 can continue the conversation with other configuration programs by making additional requests from load list 215. Through the conversation program 115 can establish set of configuration parameters 220, as described in conjunction with FIG. 1, FIG. 2 and FIG. 3. Program 115 can use set of configuration parameters 220 to determine how to handle the client application request (e.g. www.idetic.com).

Each time a new client application request is received, program 115 can initiate a new conversation to establish set of configuration parameters 220 that dictate how that client application request should be handled. Alternatively, program 115 can cache configuration parameters based, for example, on special parameters received from a configuration source. Thus, if program 115 receives a second client application request for www.idetic.com, program 115 can use the cached parameters rather than initiating a new conversation. The special parameters received from the configuration sources can be used to determine how long particular configuration parameters should be cached. While program 115 is described in terms of a web proxy server, it should be understood that program 115 can be implemented in any proxy known in the art. Moreover, the configuration sources can be located on either side of the proxy with respect to the client applications. In other words, the configuration sources can be located on the Internet and/or the corporate LAN.

Although the present invention has been described in detail herein with reference to the illustrative embodiments, it should be understood that the description is by way of example only and is not to be construed in a limiting sense. It is to be further understood, therefore, that numerous changes in the details of the embodiments of this invention and additional embodiments of this invention will be apparent to, and may be made by, persons of ordinary skill in the art having reference to this description. It is contemplated that all such changes and additional embodiments are within the spirit and true scope of this invention as claimed below.

What is claimed is:

1. A system for establishing a set of configuration parameters comprising a software program stored on a computer readable memory and executable by a computer processor to:
send a first request over a network to a first configuration source;
receive a first response over the network, wherein said first response includes a first portion of the set of configuration parameters;
send a second request over the network to a second configuration source; and
receive a second response over the network, wherein said second response includes a second portion of the set of configuration parameters.

2. The system of claim 1, wherein said first request and said second request are based on a load list.

3. The system of claim 1, wherein said second request is based on a previous response to a previous request.

4. The system of claim 3, wherein said software program is further executable to:
send a plurality of requests to a plurality of additional configuration sources; and
receive a plurality of responses from said plurality of additional configuration sources, wherein at least one of said plurality of responses contains at least a third portion of the set of configuration parameters.

5. The system of claim 4, wherein said second request is based on at least one of the plurality of responses.

6. The system of claim 5, wherein at least one of said plurality of requests are based on a set of initial parameters.

7. The system of claim 3, wherein said first configuration source and said second configuration source are the same configuration source.

8. The system of claim 3, wherein the previous response includes a set of additional request information and wherein said second request is based on said set of additional request information.

9. The system of claim 8, wherein said second request includes an additional request parameter from said set of additional request information.

10. The system of claim 9, wherein said previous request comprises said first request and said previous response comprises said first response.

11. The system of claim 9, wherein said second request includes a plurality of additional request parameters.

12. The system of claim 11, wherein said plurality of additional request parameters come from a plurality of previous responses.

13. The system of claim 1, wherein said first request and is based on a client application request received by the software program.

14. The system of claim 13, wherein said software program is further executable to make a request to a configuration server each time a client application request is received.

15. The system of claim 13, wherein said first response further contains at least one special parameter establishing caching directives for at least said first portion of the set of configuration parameters.

16. A system for establishing a set of configuration parameters comprising:
a network
a first computer in communication with the network further comprising:
a first computer processor;
a first computer readable memory accessible by the first computer processor;
a first computer network adapter device in communication with the first computer processor and operable to communicate data over the network;
a first computer program comprising instructions stored on the first computer readable memory and executable by the first computer processor to:
send a first request over a network to a first configuration source;
receive a first response over the network including a first portion of the set of configuration parameters;
send a second request over the network to a second configuration source; and
receive a second response over the network, wherein said second response includes a second portion of the set of configuration parameters; and
a plurality of configuration sources in communication with the network, each configuration source further comprising:
a configuration source computer processor;
a configuration source computer readable memory accessible by the configuration source computer processor;
a configuration source network adapter device in communication with the configuration source computer processor and operable to communicate data over the network;
a configuration source program comprising instructions stored on the configuration source computer readable memory and executable by the configuration source computer processor to:
receive a request over the network from the first computer program; and
generate a response based on the received request.

17. The system of claim 16, wherein at least one configuration source program is further executable to generate a response by:
querying an external resource for data;
receiving an external resource response;
generating the response based on the external source response.

18. The system of claim 16, wherein at least one configuration source program is further executable to generate a response based on a request parameter received from the first computer.

19. The system of claim 16, wherein at least one configuration source program is further executable to generate a response based on system state information.

20. The system of claim 16, wherein said first request is an initial request based on an a set of initial parameters.

21. The system of claim 16, wherein said second request is based on a previous response to a previous request.

22. The system of claim 21, wherein said previous response includes additional request information and wherein said second request is based on said additional request information.

23. The system of claim 22, wherein said additional request information includes an additional request parameter and wherein said second request includes said additional request parameter.

24. The system of claim 23, wherein said second request includes a plurality of additional request parameters.

25. The system of claim 21, wherein said previous request comprises said first request.

26. The system of claim 16, wherein said first computer program is further executable to send an initial request to an initial configuration source based on a set of initial parameters.

27. The system of claim 16, wherein said first computer comprises a proxy server.

28. A method for configuring a program, comprising:
sending a first request over a network to a first configuration source;
receiving a first response over the network, wherein said first response includes a first portion of the set of configuration parameters;
sending a second request over the network to a second configuration source; and
receiving a second response over the network, wherein said second response includes a second portion of the set of configuration parameters.

29. The method of claim 28, further comprising sending the second request based on additional request information contained in a previous response to a previous request.

30. The method of claim 29, wherein the previous response upon which the second request is based includes an additional request parameter and wherein the second request includes the additional request parameter.

31. The method of claim 29, wherein the second request is based on multiple additional request parameters from one or more previous responses.

32. The method of claim 29, further comprising:
loading a set of initial parameters;
making an initial request based on the set of initial parameters.

33. The method of claim 28, further comprising generating said first response based on a system state.

34. The method of claim 28, further comprising generating said second response based on a system state.

35. The method of claim 28, further comprising querying an external resource to generate the first response.

36. The method of claim 28, further comprising querying an external resource to generate the second response.

37. The method of claim 28, further comprising specifying caching directives for said first portion of the set of configuration parameters.

38. The method of claim 28, further comprising specifying caching directives for said second portion of the set of configuration parameters.
